(19) United States
(12) Patent Application Publication
(10) Pub. No.: US 2004/0088540 A1
(43) Pub. Date: May 6, 2004

(54) Community creation between communication devices by identification of member credentials

(76) Inventors: Lawrence Marturano, Palatine, IL (US); Kenneth Douros, South Barrington, IL (US); David Wheatley, North Barrington, IL (US)

Correspondence Address: MOTOROLA, INC., 1303 EAST ALGONQUIN ROAD, IL01/3RD, SCHAUMBURG, IL, 60196

(21) Appl. No.: 10/283,606

(22) Filed: Oct. 30, 2002

(51) Int. Cl. H04L 9/32

(52) U.S. Cl. 713/156; 713/201

(57) ABSTRACT

A method for creating communities between communication devices includes a first step of creating a digital credential identifying a common affiliation or interest. A next step includes distributing the digital credential to a communication device. A second device can then query the communication device to compare whether the devices have the same or similar digital credentials. If the devices are credentialed similarly then they can communicate to form a community. In addition, other similarly credentialed devices can be queried to join into the community.

### FIELD OF THE INVENTION

The present invention generally relates to controlling information in a communication device. More particularly, the present invention relates to managing credentials in a communication system or device.

### BACKGROUND OF THE INVENTION

The use of wireless technologies continues to expand providing increased interaction between people. Moreover, new radiotelephone features and standards are dramatically elevating phone functions, over and above that of telephone conversations alone. Such new features and functions include Internet browser capability, wireless multimedia, smart phones and videophones, for example. These requirements are provided through various data services and protocols including: high speed packet data, data and image processing, Global System for Mobile Communications (GSM), General Packet Radio Service (GPRS), Enhanced Data for Global Evolution (EDGE), 3rd Generation mobile data services for the Universal Mobile Telephone Service (UMTS), Global Positioning System (GPS) service, and local or wide area connectivity services. The availability of these features and services all help to augment the communication experience with friends and family.

Along these lines, there has been a growth of applications for people to improve their communication abilities with friends and family: so-called community-based interactions. One of these applications is Instant Message (IM) wherein people can communicate in real-time with their preferred acquaintances. Another application utilizes the idea of a “buddy list” or phonebook containing a personal contact list that can be addressed as a group in communications. Other applications tailor information to enhance communication with a favored person. An example of this is the use of Internet web “cookies” that identify a user and their preferences in web-based communication. The problem with these existing ideas is that they all require the manual setup of lists or databases for particular users before a communication can take advantage of these applications. In other words, there is no way to identify members of a group or community with no a priori knowledge thereof, without manually setting up information on these members beforehand. What is needed is a technique for a more natural or transparent way for users of communication devices to affiliate with a desired group or community on an ad hoc basis.

There are techniques to store on-line user profiles on a communication device or in a service provider network, such as is found in online web services like chat facilities, etc. However, such information may not be amenable to forming communities and accessing such information can be very complicated considering the different amounts of information available, ability to find the information, and the numerous ways that this information is presented or protected. Moreover, service providers and users are unaware of the ultimate use and exact formatting of this information. One option is for a service provider to supply a list of information related to a user in a group. Another option is to store this information on the communication device. In either case, there is a problem in requiring the radiotelephone to download and store all this information and then filter it for users sharing a common interest, which wastes data throughput. Another option is to truncate these lists or information and hope that the radiotelephone of the end user can utilize the information as delivered. Of course, this may not always work, and prevents users from having the proper information.

For instance, a user of a communication device, such as a radiotelephone, may prefer that certain individuals, service or content providers have limited or restricted access to their community or group affiliations or other contextual information. As examples of this, spammers should not be able to access affiliation information, or a user may prefer to restrict access to their communication device containing a personal contact list. Therefore, it would be desirable for a user to have control and to restrict availability of affiliation information within the user's communication device.

Accordingly, there is a need for using credentials in a radiotelephone to facilitate ad hoc community formation. There is a further need to control such credentials, assign levels of subjective value or credibility and to define rules for their use. In particular, these aspects can include the ability of querying between communication devices and determining their context.

### BRIEF DESCRIPTION OF THE DRAWINGS

The features of the present invention, which are believed to be novel, are set forth with particularity in the appended claims. The invention, together with further objects and advantages thereof, may best be understood by making reference to the following description, taken in conjunction with the accompanying drawings, in the several figures of which like reference numerals identify identical elements, wherein:

FIG. 1 is an illustration of a communication system, in accordance with the present invention;

FIG. 2 is a simplified block diagram of a communication device, in accordance with the present invention;

FIG. 3 is a flow chart for a method of creating communities between communication devices, in accordance with the present invention;

FIG. 4 is a flow chart for a first alternate embodiment of a method of creating communities between communication devices, in accordance with the present invention;

FIG. 5 is a flow chart for a second alternate embodiment of a method of creating communities between communication devices, in accordance with the present invention; and

FIG. 6 is a flow chart for a third alternate embodiment of a method of creating communities between communication devices, in accordance with the present invention.

### DETAILED DESCRIPTION OF A PREFERRED EMBODIMENT

The present invention provides a technique for creating, distributing and using digital tokens (credentials) in a radiotelephone to facilitate ad hoc community formation. The credentials identify a common interest between users. In particular, the technique includes the ability of a communication devices to query other communication devices to read their credentials to see if there is a common interest and to determining if forming a group with such a device is appropriate. Aspects of appropriateness include contextual information, including location, prioritization, and a weighted rating of the user of the queried communication device. The technique described below also outlines control of credentials and defines rules for their use.

Advantageously, the present invention can be used in any mobile station or communication device, such as a radiotelephone, Personal Digital Assistant (PDA), pocket PC, or laptop computer, wherein a wireless data environment exists to form a group communication between two or more communication devices. In particular, any provider of CDMA/GSM/3G cellular handsets or CDMA/GSM/3G subscriber units (e.g. PDAs) could use the present invention. In addition, service providers and application developers will also have some impact as far as credential control and provided content. In this way, members of a common-interest group or affiliation can interact with other like-credentialed members, either by voice, e-mail, IM, and the like. As a result, the present invention allows community creation and control with the possibility of exclusive membership. Such community creation enables an ad hoc discovery of community members with a common interest based on their credentials and other contextual cues.

As an example, a person carries digital credentials in their radiotelephone identifying them as part of a particular community (e.g. a community of practice, such as the IEEE, ACM, AMA, etc.). This person is able to detect and access communities of like-credentialed individuals via their radiotelephone. For example, an ACM member may want to know, when shopping for a power tool, if another ACM member is in the store at the same time, and is willing to talk. Alternatively, the person may wish to converse with someone in the vicinity that is a part of their community of practice. This person can also participate in a chat, voice or e-mail communications with other members of the credentialed community. Management of the credentials can be done by the service provider or carrier or a credential-issuing organization. A generalization of this concept is to implement cellular “cookies”, wherein a user's radiotelephone has markers deposited therein by others and viewable by others at the user's discretion. These individually addressed markers are secure, and can be credentials as described above, certificates, licenses, keys, tokens, control packets, or other digital information.

The present invention also includes an embodiment wherein a communication device can continually broadcast information to others, possibly in the vicinity, using a wireless local area network (WLAN) or other proximity based networking technology. This information can be used to form an ad hoc community of interest. This invention allows users to connect with others who have similar interests in a much less intrusive, more automatic way than is possible today. For example, a user's device can passively scan to see if anyone having a credential of interest is nearby, and notify the user of that fact.

As a specific example, a person may be very knowledgeable about PVC pipe. When in a hardware store, this person may broadcast either this specific information or simply that they are available for consultation on this topic. Micropayments may be charged for this information. The information may also be ratings based, i.e. what the person bought and their review or opinion about it, task-based dependent on the knowledge required, and interest-based. Retail locations may also implement information broadcasting in their own stores to help customers with purchases. Moreover, a person could be able to leave information lying around on a carrier-based or local-based server for others to find later. This storage of information can be based on GPS or other contextual cues, and typically uses a lower security protection than with digital credentials themselves. Micropayments may be charged for this information, also. In operation, a user entering the store can activate their device to scan for information or individuals having a common interest. Alternatively, a user can have their device constantly and passively scan for information or individuals having a common interest. Moreover, the user can have their device filter any findings depending on their context or the context of the individual with the information. Further, the device can passively or actively store any found information for later use by the user.

In another embodiment, the present invention provides a way for a user to find others who belong to the same or similar community. Optionally, the user can weight communications from people with a similar affinity based on the similarity of the communities belonged to. Along these lines, a user can treat special communities, that are known as implicitly trustworthy or explicitly verified such as a church membership or a background-checked and identity-certified group, as markers for whom to trust, whom to communicate with, or whose communications to me are of a higher priority, having longer time-outs, or are delivered in some other markedly different way than others who are not members of these groups. Preferably, the weighting is dynamically assigned by the querying device based on context wherein, for example, a church member would have a higher weighting when in church and a lower weighting in a hardware store.

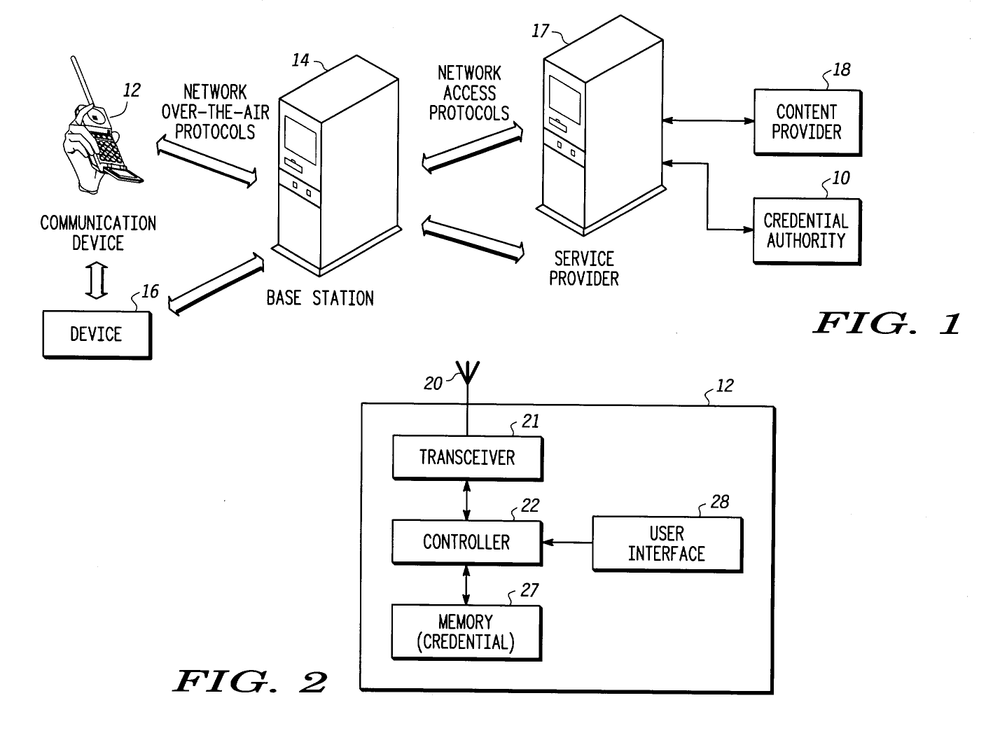

FIG. 1 presents an overview of the communication system with credential interactions to create communities, in accordance with the present invention. The communication system includes a central authority 10 that controls the issuance and distribution of digital credentials. The digital credentials identify a common interest, affiliation, or group. For example, the authority can create a unique credential that identifies the AMA. This credential can be distributed to verified AMA members, such as communication devices 12, 16 (e.g. radiotelephones).

Distribution of credentials and information exchange is conducted through existing communication infrastructure 14 such as a base stations (as shown), gateways, or networks, using existing standard network over-the-air protocols for data exchange. This connection can be in any standard communication system and can be to a wide area network (WAN), for example. The communication device 102 can also be configured to accommodate local connectivity, such as to local area network (LAN). This connection can be wired or wireless. The exchange can also be accomplished through Short Messaging System, for example, or other data exchange technique. Data or information exchange is facilitated through a service provider and network access protocols, as are known in the art. Information exchange can be directly between devices 12, 16, indirectly between devices using the communication infrastructure 14 and service provider 17, or between the communication devices 12,16 and a content provider 18 working through the service provider 17. Optionally, the service provider 17 and content provider 18 are the same entity. Along these lines, the credential authority 10 can also be the same entity as one or more of the service provider 17 and content provider 18.

In operation, a first communication device 12 contains a digital credential identifying a common interest. A second communication device 16 also has a digital credential identifying a common interest. The second communication device 16 is configured to query the first communication device 12 to determine if there is a substantial match between their respective digital credentials so as to facilitate the formation of a community sharing a common interest therebetween.

It is envisioned that the exchange of information is transparent to one or more of the users of the communication devices 12, 16. In this case, there is an issue of privacy, wherein a user can go into another users radiotelephone to pull out information without their knowledge. Therefore, it is desirable that the first communication device 12 defines a permission or provides an allowance for the second communication device 16 to read the digital credential of the first communication device 12.

There is also the issue of limiting the scope of the community created. In other words, a user may not wish to search out every possible communication device having the same credentials as themselves. This would be time consuming and would stifle interaction with having too many group members online. The present invention solves this problem by providing a context of the communication devices. Contextual information is used to gauge whether or not to form a community with any particular device. One form of context can defined the party of interest (e.g. specific individuals, subscribed services, service or content providers, etc.). Another context can include the location of a particular device, it operating status, its environment, the time, etc.). These criteria are used to decide whether to implement a communication with any particular device to form a group or community.

The actual contextual information can involve local storage of context on the particular device, remote storage on a server, or can be determined, defined or limited empirically. For example, if a user wants to talk face-to-face with someone who can help them in a store, the user can limit its search for similarly credential members through only the microcell network of the store itself (i.e. location limited context). Optionally, a communication device can broadcast its digital credential, which would greatly ease search times. In an alternate embodiment, the first communication device can tag information relating to the common interest with the digital credential and store the tagged information, either locally or remotely, for retrieval by the second communication device.

Where there are no credential found that match a users credential it is possible to score or weight the similarity of digital credentials based on a degree of shared affinity of the interests associated with each digital credential and measuring a match between credentials using the weighting. If there are many similarly credentialed users available, the weighting can be augmented by including a predetermined prioritization of digital credentials. Moreover, a user can weight the similarity of digital credentials based on a predetermined rating, as explained previously, assigned to the first communication device or its user and measuring a match using the weighting. Preferably, the rating is defined by the community itself and the rating can be changed using input from members of the community and by the service provider.

Referring to FIG. 2, each of the communication devices 12 (16) can create a community. Although only two devices 12,16 are shown, many more can be involved in the community. Each of the devices 12 (16) is typically a cellular telephone with an internal bus for connection of the internal components of the cellular telephone together and to the user interface 28. The internal bus is under control of a central processing unit (CPU) or controller 22. A memory 27 with radiotelephone control software, and containing the digital credential and associated information, connects to the internal bus and provides control of the functionality of the cellular telephone as well as information transfer. A radio RF subsystem connects to an antenna 20 via a transceiver 21 used in communicating information between communication devices. The radio subsystem is operated according to standard cellular telephone air interface specifications under control of the radiotelephone control software memory. The user interface 28 is also operated over the internal bus of the cellular telephone and can include input and output devices such as a microphone, a speaker, a keyboard and a display that are not shown for simplicity.

The memory 27 is arranged to contain credential of the user of the communication device 12 that can be downloaded by the credential authority through the communication network. The controller 22 is used to query other communication devices through the transceiver 21 for a digital credential of another communication device or user. The controller 22 then can compare, rate, and weight the credential of the other device or user to the resident credential in order to measure if there is a direct match or substantial match or shared affinity of interests, in order to determine whether to initiate a community therebetween. The weighting, when used, can include a predetermined prioritization of digital credentials, or the weighting can be based on a predetermined rating of a device and determine a match using this weighting. The rating can be changed using input from other members of the community and by a service provider serving the community. The controller 22 can also determine the context of other communication devices before forming a community therewith, as explained previously. In addition, the controller can initiate a search in a communication network for stored information tagged with a digital credential.

The controller 22 also stores the credential identifying a common interest in the memory 27, and controls access to the credential, when allowed, to be downloaded through the transceiver circuitry 20,21 of the device 12 (16) to a querying communication device. Optionally, the transmitter 21 can broadcast the credential stored in memory 27.

The user interface 28 can be used by a user to manually assign access or permission to the digital credential. Alternatively, access to a user's digital credential can be assigned as part of an automatic operation. Preferably, the access limitations can include security protocols to limit access to other members of the same or similar community. For example, a password can be used or the device can pass tokens to a querying device before allowing credential access. An acknowledgement or token can be associated with the access allowance as well as being based on the content itself. For example, an individual requesting a credential for the user could be prompted for a password or PIN, or if password is not known, request the password. This can include a user acknowledge and/or the distribution of an automated key or token separate from the credential. In this case, the key or token can be administered by the credential authority. Along these lines, the credential can be subject to verification and can expire based on predefined criteria. In addition, the credential and a key can be combined using a hashing algorithm distributed by the authority securely and viewed by only those with the key to decode it.

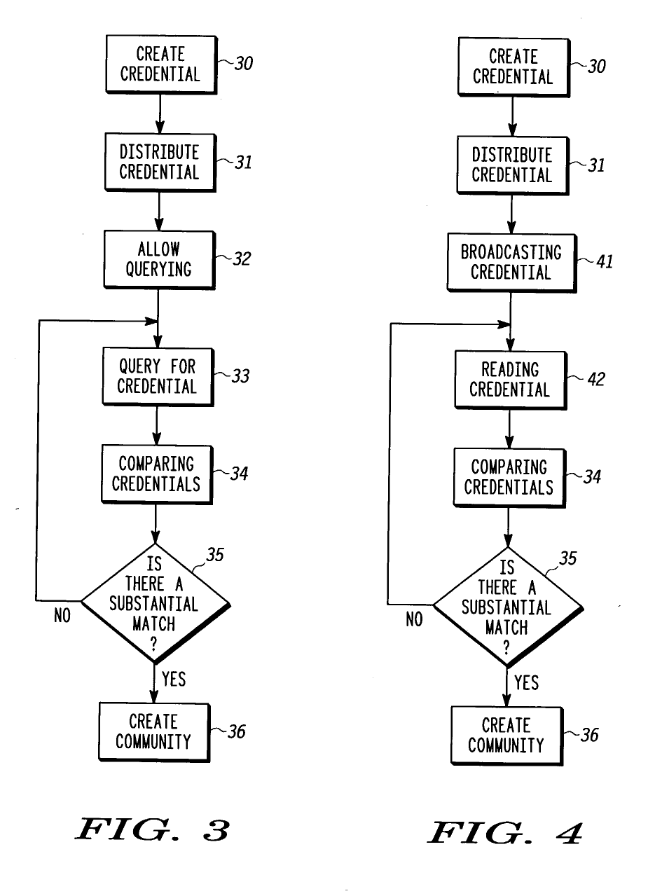

FIG. 3 shows a method for creating communities between communication devices. The creation of communities is based upon a digital credential identifying a common interest, such as a group affiliation. A central authority administers the credentials by creating 30 a digital credential identifying a common interest, and distributing 31 the digital credential to at least one communication device. The distribution of the credential is performed over standard communication channels using existing known techniques. The digital credentials can include one or more of: cellular cookies, Internet cookies, tokens, certificates, licenses, keys, digital identification, and the like.

The credential is stored in the communication device, and can be retrieved by another communication device by querying 33 of the communication device. The method continues by comparing 34 the retrieved credential with the resident credential to see if there is a substantial match 35. The matching can be exact or can be similar as defined as credentials having a similar interest or affiliation. Similarities can be predefined by a user through past experience or coded into the credential. If there is no substantial match then other devices can be queried 33 until a substantial match is found or no other devices can be queried. If there is an exact or close (as defined by the needs of a user) match of credentials, then a community can be created by initiating 36 communication between the like-credential devices.

Close matches 35 can be determined by weighting the similarity of digital credentials based on a degree of shared affinity of the interests associated with each digital credential and determining a match using the weighting. In this case, it is preferred that the weighting includes a predetermined prioritization of digital credentials, as explained before. Alternatively, the comparing step 34,35 includes weighting the similarity of digital credentials based on a predetermined rating of the communication device and determining a match using the weighting. In this case, it is preferred that the rating can be changed using input from other members of the community. Optionally, the rating can be provided by a network operator of a communication system of the communication devices. If the weighting or rating is above a criterion value established by the user then a close match is indicated.

Preferably, the comparing step 34,35 includes determining the context of the communication device and deciding upon communicating between the communication devices depending upon the context. Context is used here as described previously. More preferably, the method includes, after the distributing step 31, the step of allowing 32 the communication device to be queried for its credential by other communication devices.

FIG. 4 shows an alternate embodiment for creating communities between communication devices. The creating 30 and distributing 31 step are the same as in the method of FIG. 3. However, in this embodiment a communication device includes the step of broadcasting 41 of the digital credential by the communication device, which can then be queried or read 42 by another communication device. The broadcast credential and the resident credential can then be compared 34, as before, to see if there is a substantial match 35 to create 36 a community. Preferably, the comparing step 34,35 includes determining the context of the communication device and deciding upon communicating between the communication devices depending upon the context.

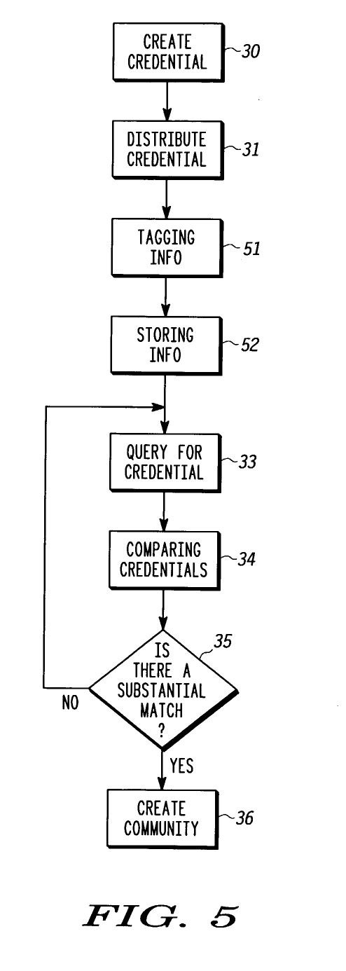

FIG. 5 shows a second alternate embodiment for creating communities between communication devices. The creating 30 and distributing 31 step are the same as in the method of FIG. 3. However, in this embodiment a communication device includes the steps of tagging 51 information relating to the common interest with the digital credential and storing 52 the tagged information for retrieval by the another communication device, which can then be queried or read 42 by another communication device. The credential of the tagged information and the resident credential can then be compared 34, as before, to see if there is a substantial match 35 to initiate a communication to create 36 an information community. Preferably, the comparing step 34,35 includes determining the context of the communication device and deciding upon communicating between the communication devices depending upon the context.

In another embodiment, the present invention establishes the identity, credibility or trustworthiness of the participants or new entrants in the ad-hoc group or community. Without this kind of check there could be potent hazards and could enable those with criminal tendencies to abuse such ad-hoc groups of users. For example, pedophiles, sex offenders, con-artists and others might gain access into such groups and use the communications for inappropriate purposes. Internet chat-rooms are currently subject to similar problems. In this case, the problem is solved by shutting out unwanted participants or blocking their re-entry. However, this can only be done after the user has entered the group and an address or identity is known and recognized. There is no method currently available to screen someone wishing to join a user group on the basis of certain criteria and to prevent them from entering or participating in the first place.

Another alternate embodiment of the present invention solves this problem by assigning “ratings” to a communication device by enabling a group member or group moderator or other groups or organizations (e.g. law enforcement) to establish the appropriateness of permitting a participant into an ad-hoc group without alerting the user of that communication device to the fact that they are being rated. It also enables this filtering to occur before the participant has joined the group rather than afterwards. Preferably, the user is required to log on to the device (using biometrics, password, SIM card or other personal identification technique) such that the “rating” is actually assigned to the user of that device instead of the device itself, and the rating is enabled when that user is logged on.

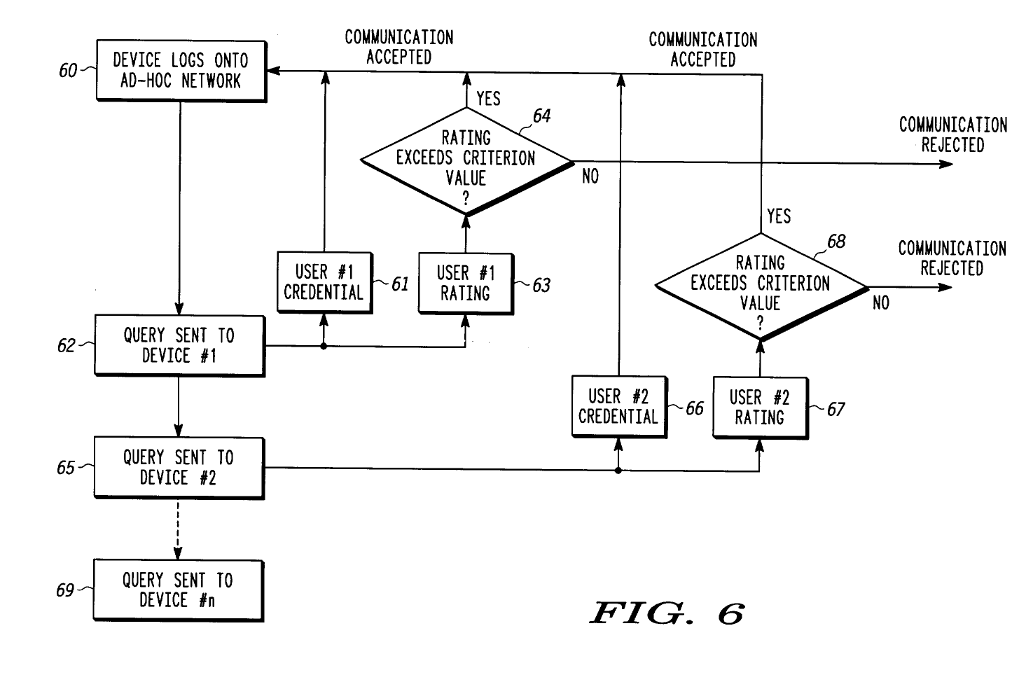

Referring to FIG. 6, an ad hoc group is formed as described previously in accordance with FIG. 3, for example. A device wishing to join the group logs on 60 using an unique identification of that user that can be relayed by the device the user is using. As a default, the device could have its own unique identifier. Preferably, the digital credential 61 is used for this identification. The network operator, moderator or administrator, then queries the device 62 for a rating 63 associated with the user credential 61 and rejects the communication if the rating falls below some predefined level or criterion value 64. Other devices wish to join the group are similarly tested 65-69.

The predetermined criterion or level to accept a particular user into a group can optionally be defined through a process of electronic negotiation between the existing members of the ad hoc group. Such ratings may be automatically generated or user assigned based upon various criteria. Some examples include trustworthiness, membership of professional or other groups, etc. At a basic level, a rating can be assigned by the wireless network operator, for example, as a subscriber who has a verified address and social security number or other identifier, and who has consistently paid their bills on time. Additional “rating points” can be awarded spontaneously by other members of an ad hoc group. This “credibility rating” thus becomes analogous to the well-understood “credit rating” and may be used as a key to gain access to ad hoc or other wireless user groups.

The rating is applied to users of devices rather than to devices themselves (unless defaults are used), and can be stored on each user device. However, it is preferred that an administrator control and assign the rating for each of the group members. The rating can then be mapped against user credentials stored in a database controlled by the administrator or downloaded from remote storage.

As can be seen from the foregoing, the present invention provides a method and system for creating communities between communication devices. While a particular embodiment of the present invention has been shown and described, modifications may be made. It is therefore intended in the appended claims to cover all such changes and modifications which fall within the broad scope of the invention.

What is claimed is:

1. A method for creating communities between communication devices, the method comprising the steps of:
creating a digital credential identifying a common interest;
distributing the digital credential to at least one communication device;
querying of the communication device by another communication device;
comparing the digital credentials of the communication devices and indicating a substantial match therebetween;
communicating between the communication devices having a substantial match of digital credentials to form a community.

2. The method of claim 1, wherein after the distributing step further comprising the step of allowing the communication device to be queried by other communication devices.

3. The method of claim 1, wherein the comparing step includes determining the context of the communication device and deciding upon communicating between the communication devices depending upon the context.

4. The method of claim 1, wherein the digital credentials of the creating step are one or more of the group of: cellular cookies, internet cookies, tokens, certificates, licenses, keys, and digital identification.

5. The method of claim 1, wherein after the distributing step further comprising the step of broadcasting of the digital credential by the communication device.

6. The method of claim 1, further comprising the step of tagging information relating to the common interest with the digital credential and storing the tagged information for retrieval by the another communication device.

7. The method of claim 1, wherein the comparing step also includes weighting the similarity of digital credentials based on a degree of shared affinity of the interests associated with each digital credential and determining a match using the weighting.

8. The method of claim 7, wherein the weighting includes a predetermined prioritization of digital credentials.

9. The method of claim 1, wherein the comparing step includes weighting the similarity of digital credentials based on a predetermined rating of the communication device and determining a match using the weighting.

10. The method of claim 9, wherein the rating can be changed using input from members of the community.

11. The method of claim 9, wherein the rating can be provided by a network operator of a communication system of the communication devices.

12. A system for creating communities between communication devices, the system comprising:
a central authority that controls issuance and distribution of digital credentials;
a first communication device having a digital credential identifying a common interest;
a second communication device having a digital credential identifying a common interest, the second communication device being configured to query the first communication device to determine if there is a substantial match between their respective digital credentials so as to facilitate the formation of a community therebetween; and
a service provider that provides communication between the first and second communication devices.

13. The system of claim 12, wherein the first communication device can allow the second communication device to read its digital credential.

14. The system of claim 12, wherein a context of the first communication device is provided to the second communication device for the second communication device to decide whether to form the community.

15. The system of claim 12, wherein the first communication device can broadcast its digital credential.

16. The system of claim 12, wherein the first communication device can tag information relating to the common interest with the digital credential and store the tagged information for retrieval by the second communication device.

17. The system of claim 12, wherein the second communication device can weight the similarity of digital credentials based on a degree of shared affinity of the interests associated with each digital credential and measuring a match using the weighting.

18. The system of claim 17, wherein the weighting includes a predetermined prioritization of digital credentials.

19. The system of claim 12, wherein the second communication device can weight the similarity of digital credentials based on a predetermined rating and measuring a match using the weighting.

20. The system of claim 19, wherein the rating can be changed using input from members of the community and by the service provider.

21. A communication device capable of creating a community between communication devices, the device comprising:
a digital credential stored in a memory, the digital credential identifying a common interest;
a transceiver for communication information between communication devices;
a controller coupled to the transceiver and the memory, the controller configured to query other communication devices through the transceiver for a digital credential of another communication device to determine if there is a substantial match between digital credentials of the communication devices so as to facilitate the formation of a community therebetween.

22. The device of claim 21, wherein the controller can determine the context of other communication devices before forming a community therewith.

23. The device of claim 21, wherein the controller can search a communication network for stored information tagged with a digital credential.

24. The device of claim 21, wherein the controller can weight the similarity of digital credentials based on a degree of shared affinity of the interests associated with each digital credential and determining a match using the weighting.

25. The device of claim 24, wherein the weighting includes a predetermined prioritization of digital credentials.

26. The device of claim 21, wherein the controller can weight the similarity of digital credentials based on a predetermined rating of the other communication device and determine a match using the weighting.

27. The device of claim 26, wherein the rating can be changed using input from other members of the community and by a service provider serving the community.
